(19) United States
(12) Patent Application Publication
(10) Pub. No.: US 2023/0301272 A1
(43) Pub. Date: Sep. 28, 2023

(54) LIVESTOCK MANAGEMENT SYSYEM AND METHOD

(71) Applicant: CLIPEX IP LIMITED, Road Town, Tortola (VG)

(72) Inventor: Ashley Dean Olsson, Goulburn, NSW (AU)

(21) Appl. No.: 18/030,257

(22) PCT Filed: Aug. 23, 2021
(86) PCT No.: PCT/AU2021/050937

§ 371 Date: Apr. 4, 2023

(30) Foreign Application Priority Data
Sep. 4, 2020 (AU) 2020903169

(51) Int. Cl. A01K 15/00; A01K 13/00; A01K 11/00; A01K 1/00; A01K 29/00

(52) U.S. Cl. CPC A01K 15/00; A01K 13/003; A01K 11/006; A01K 13/001; A01K 1/0017; A01K 29/005

(57) ABSTRACT

The present invention relates to a livestock management system. The system includes a stockyard. A suspended herder is provided for herding livestock in the stockyard. Advantageously, the herder facilitates the removal of people from within confined spaces where animals are present within the stockyards, whilst still enabling controlled stock movements to be safely, calmly, and efficiently performed.

### CROSS-REFERENCE TO RELATED APPLICATION

This application is a U.S. National Stage Application under 35 U.S.C. § 371 of International Patent Application No. PCT/AU2021/050937, filed 23 Aug. 2021, which claims the benefit of Australian Patent Application No. 2020903169, filed 4 Sep. 2020, each of which is hereby incorporated by reference herein in its entirety.

### TECHNICAL FIELD

The present invention relates to a livestock management system and method.

### BACKGROUND

The reference to any prior art in this specification is not, and should not be taken as an acknowledgement or any form of suggestion that the prior art forms part of the common general knowledge.

It is common practice for livestock to be moved into, held in, and moved around in confined spaces such as a set of animal handling yards for Animal husbandry purposes and livestock management and sales operations.

Animals are held in a series of contained spaces with interconnecting gates and laneways and are often put through a handling device such as a cattle crush, weigh box or sheep handler or drafter, or loading ramp.

Regular practices such as health checks, ear tagging, giving needles, administering drenches, weighing and categorizing of animals are carried out within the stockyards. Such practices require people to be in close proximity to live animals often opening gates and encouraging livestock to move from one pen to another. Handling livestock in such stockyards is a dangerous practice with regular instances of serious injury and at the very worse, fatalities are caused by direct animal impact or blunt force trauma caused by animals impacting gates that, in turn, impact the workers.

The preferred embodiment provides for a safer working environment for performing the necessary operations required within a stockyard.

### SUMMARY OF THE INVENTION

According to one aspect of the present invention, there is provided a livestock management system including:
a stockyard; and
a suspended herder for herding livestock in the stockyard.

Advantageously, the herder facilitates the removal of people from within confined spaces where animals are present within the stockyards, whilst still enabling controlled stock movements to be safely, calmly, and efficiently performed.

The herder may be line suspended. The system may further include one or more lines (e.g. wires, ropes or cables) being connected to the herder. The lines may be extendable and retractable. The system may include one or more individual mechanisms capable of facilitating the extension and retraction of each of the respective lines. The system may include one or more structures from which the lines extend and between which the herder can be maneuvered. The structures may be existing building infrastructure or installed to support respective line extension and retraction mechanisms.

The herder may include a suitably designed mechanism for attaching and releasing objects or apparatuses. The herder may include or be capable of attaching a suitably designed apparatus for encouraging livestock to stop or move as and when required in a preferred location or direction. The apparatus that encourages livestock to move or stop may include a mannequin. The herder may include or be capable of connecting a suitably connected device to disperse liquids. The dispersing of liquids can be for cleaning, application of pharmaceuticals onto or into the livestock by spray or injection. The herder may be capable of unilateral or bilateral communication with livestock identification systems or be capable of being connected to an apparatus that is capable of unilateral or bilateral communications systems.

The system may include a controller for controlling the herder. The controller may position the herder in three dimensions (3D) within the stockyard (i.e. in the x, y and z planes). The controller may further alter the degree of turn or orientation of the herder. The controller may automatically control the herder to be responsive to the movement of livestock.

The stockyard may include one or more gates. The controller may control the gates to open and close in synchrony with positioning of the herder. The stockyard may include one or more holding pens for holding or displaying the livestock. The stockyard may include one or more laneway for moving livestock.

The herder may include a temperature sensor for measuring the temperature of stock. The controller may record the temperature against the individual animal in a database. The herder may include a noise generator.

The herder may include a camera for capturing and conveying images of livestock. The controller may image process individual animals and/or a herd to record or determine characteristics or data specific to any one animal or a group of animals such as, but not limited to, weight, colour, health, fleece data, breed, sex, age, individual identity or numbers thereof. The system may include a counter for counting livestock.

According to another aspect of the present invention, there is provided a livestock management method involving:

Herding or segregating livestock in a stockyard with a suspended herder.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a plan view of a livestock management system in accordance with an embodiment of the present invention; and

FIG. 2 is a perspective view of the system of FIG. 1.

### DETAILED DESCRIPTION OF PREFERRED EMBODIMENTS

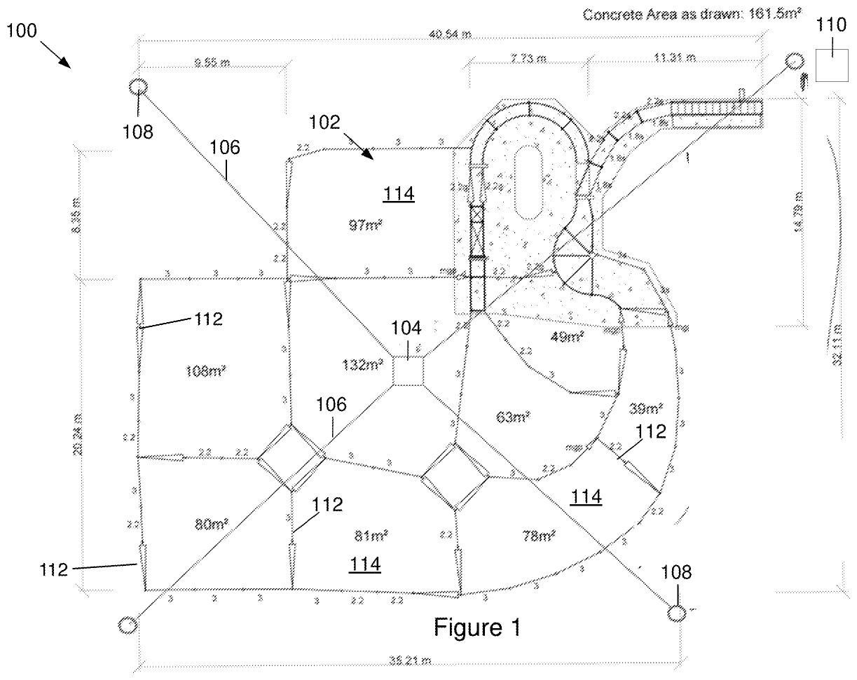

According to an embodiment of the present invention, there is provided a livestock management system 100 as shown in FIG. 1. The system 100 includes a stockyard 102, and a suspended electro-mechanical herder 104 for herding livestock in the stockyard 102. Advantageously, the herder 104 facilitates the removal of people within close proximity to livestock in confined spaces within the stockyard 102, enabling animal movements to be safely and efficiently performed.

The system 100 further includes four lines 106 (e.g. wires, ropes or cables) extending from the herder 104. The lines 106 are extendable and retractable whereby the system 100 includes four winches for winching respective lines 106. The system 100 also includes four towers or mounting points 108 from which the lines 106 extend and between which the herder 104 can be maneuvered by actuating the extension-retraction mechanisms. The extension-retraction mechanisms are supported by the towers or mounting points 108. support.

The herder 104 also includes a mechanism for picking up and releasing apparatus and objects. Further, the herder 104 includes an apparatus to encourage and control livestock movements. Typically, the apparatus includes a human-like mannequin which is attached via a connect and release mechanism. The herder 104 also includes a device for dispensing liquids for cleaning areas of the stockyards and cleaning objects such as water troughs. The dispensing apparatus connected to the herder 104 can dispense pharmaceuticals onto or into animals via spray or injection.

The system 100 also includes a controller 110 for controlling the herder 104. The controller 110 positions the herder in three dimensions (3D) within the stockyard (i.e. in the x, y and z planes). Further, the controller can alter the degree of turn or rotational orientation of the herder 104.

The stockyard 102 includes gates 112 located on the outer perimeter and between adjacent holding pens 114 for holding livestock. The controller 110 controls the gates to open and close in synchrony with positioning of the herder 104 and movement of the livestock through the pens 114 of stockyard 102.

The herder 104 also includes a temperature sensor for measuring the temperature of individual or collective stock. The controller 110 records the temperature against the individual NLIS or other livestock identification system tagged animal in a database. The herder 104 also includes an apparatus capable of communicating either unidirectionally or bi-directionally with livestock identification systems or their components such as, but not limited to NLIS tags.

Furthermore, the herder 104 includes a camera for capturing images of livestock. The controller 110 image processes individual animals and/or a herd to determine weight, colour, health, fleece data, breed, sex, age, individual identity (by facial recognition or other unique animal characteristics) or counted numbers thereof.

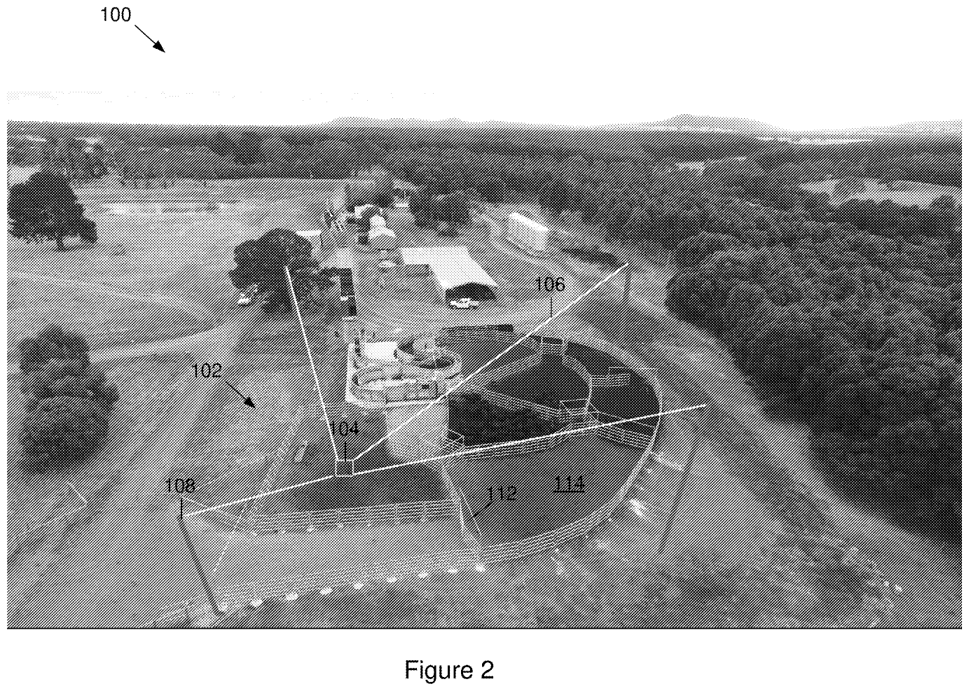

FIG. 2 shows a perspective view of the system 100.

A livestock management method using the system 100 is now briefly described.

The herder attaches a human-shaped mannequin which is then suspended from below the herder, creating an impression to the livestock that a worker is moving inside the stockyard 102 to encourage and control stock movement. When such a mannequin is in use, the herder 104 is capable of making noise and or projecting noise or projecting at least one hologram to encourage low-stress, worker-less animal handling.

The method involves the controller 110 controlling the extension-retraction mechanisms to herd the livestock through the pens 114 with the suspended mannequin under the herder 104. As required the controller opens at least one gate 112 before the livestock approach the gate, this reduces stock stress and increases efficiency, with the controller opening and closing the gate 112 without the need for a person to be present allowing for low-stress stock movements, whilst at the same time eliminating the need for workers to be in close proximity to livestock in the “animal zones” such as the pens 114. The camera is capable of sensing animals and their movements, and the controller 110 automatically controls the herder 104 to respond accordingly and is capable of projecting at least one hologram image or sound to create a presence that is larger than the herder or the mannequin suspended under it. Stock are herded in a desired path of direction, and the herder 104 is capable of quick movement to check the animal's direction causing the animal to baulk and move back in the intended direction, be that through a gateway, laneway or in a particular direction within the stockyard 102.

The system 100 can also perform a stock take of the livestock, recording the measured livestock temperatures, weight, identity or other unique animal data and count numbers of livestock.

After herding, the apparatus that encourages and controls the movements of the livestock can be released from the herder and replaced with another apparatus such as the apparatus used to dispense liquids to clean down certain areas or structures, such as feed troughs, to reduce dust and to improve cleanliness, or another apparatus such as that which sprays or injects pharmaceuticals.

A person skilled in the art will appreciate that many embodiments and variations can be made without departing from the ambit of the present invention.

In compliance with the statute, the invention has been described in language more or less specific to structural or methodical features. It is to be understood that the invention is not limited to specific features shown or described since the means herein described comprises preferred forms of putting the invention into effect.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

1. A livestock management system comprising:
a stockyard;
a suspended herder for herding livestock in the stockyard;
one or more extendable and retractable lines connected to the herder; and
one or more individual mechanisms capable of facilitating the extension and retraction of each of the respective lines.

2. (canceled)

3. (canceled)

4. (canceled)

5. A livestock management system as claimed in claim 1, comprising one or more structures from which the lines extend and between which the herder can be maneuvered, said structures being selected from the group consisting of existing building infrastructure, and installed structures, to support the respective line extension and retraction mechanisms.

6. A livestock management system as claimed in claim 1, wherein the herder comprises a mechanism for attaching and releasing objects or apparatuses.

7. A livestock management system as claimed in claim 1, wherein the mechanism for attaching and releasing objects or apparatuses is capable of attaching an apparatus for encouraging livestock to stop or move as and when required in a preferred location or direction.

8. A livestock management system as claimed in claim 1, wherein the herder comprises or is capable of connecting to a device for dispersing liquids.

9. A livestock management system as claimed in claim 8, wherein the dispersing of liquids is for performing an operation selected from the group consisting of cleaning, and the application of pharmaceuticals onto or into the livestock by spray or injection.

10. A livestock management system as claimed in claim 1, wherein the herder is capable of unilateral or bilateral communication with livestock identification systems or is capable of being connected to an apparatus that is capable of unilateral or bilateral communications.

11. A livestock management system as claimed in claim 1, comprising a controller for controlling the herder.

12. A livestock management system as claimed in claim 11, wherein the controller is capable of controlling one or more tasks selected from the group consisting of:
positioning the herder in three dimensions, namely the x, y and z planes, within a designated space containing livestock;
controlling gates to open and close in synchrony with positioning of the herder;
altering the degree of turn or orientation of the herder; and
automatically controlling the herder to be responsive to the movement of livestock.

13. A livestock management system as claimed in claim 1, wherein the stockyard comprises one or more of the stockyard structures selected from the group consisting of one or more gates, one or more holding pens for holding or displaying the livestock, and, one or more laneways for moving livestock.

14. A livestock management system as claimed in claim 1, wherein the herder comprises a temperature sensor for measuring the temperature of livestock animals.

15. A livestock management system as claimed in claim 1, wherein the herder comprises a feature selected from the group consisting of a noise generator, a holographic image creator, a holographic image projector, a digital image creator, a digital image projector, a counter for counting livestock, and, a camera for capturing and conveying images of livestock.

16. (canceled)

17. (canceled)

18. A livestock management system as claimed in claim 15, configured to image process individual livestock animals and/or a herd to record or determine characteristics or data specific to any one animal or a group of animals.

19. (canceled)

20. A livestock management method comprising a step of herding or segregating livestock in a stockyard with a suspended herder, wherein one or more extendable and retractable lines are connected to the herder, and one or more individual mechanisms facilitate the extension and retraction of each of the respective lines.

21. A method of supporting or suspending at least one device from at least one line within an area used for holding, sorting, counting, weighing or selling livestock, where the at least one device is capable of being moved in at least two axes, and where the at least one device is capable of influencing animal movements, measuring, identifying or determining individual animal or herd data or characteristics, counting animals, or communicating with animal identification systems or their components.

22. A method as claimed in claim 21, wherein the at least one device is capable of connecting to and disconnecting from at least one apparatus.

23. (canceled)

24. (canceled)

25. A method as claimed in claim 21, wherein the at least one device is able to apply or inject pharmaceuticals onto or into animals.

26. A method as claimed in claim 22, wherein the at least one apparatus is capable of encouraging livestock to stop or move as and when required in a preferred location or direction.

27. A livestock management system as claimed in claim 7, wherein the apparatus comprises a mannequin.

28. A livestock management system as claimed in claim 14, wherein the livestock management system is capable of recording the temperature of an individual livestock animal in a database.
